(19) United States
(12) Patent Application Publication
(10) Pub. No.: US 2024/0281287 A1
(43) Pub. Date: Aug. 22, 2024

(54) SERVICE LEVEL OBJECTIVE MAINTENANCE USING CONSTRAINT PROPAGATION

(71) Applicant: INTERNATIONAL BUSINESS MACHINES CORPORATION, ARMONK, NY (US)

(72) Inventors: Swaminathan Balasubramanian, Troy, MI (US); Pierre C. Berlandier, San Diego, CA (US); Renganathan Sundararaman, Cary, NC (US); Gayatri Renganathan, Cary, NC (US); Rajiv Joshi, Yorktown Heights, NY (US)

(21) Appl. No.: 18/172,369

(22) Filed: Feb. 22, 2023

(51) Int. Cl. G06F 9/50

(52) U.S. Cl. CPC G06F 9/5027

(57) ABSTRACT

An embodiment for maintaining service level objectives in container orchestration platforms using constraint propagation. The embodiment may receive a set of service level objectives associated with deployment of an application. The embodiment may determine a series of resource dependencies corresponding to the received set of service level objectives for the application. The embodiment may generate a first set of constraints corresponding to service requirements for the received set of service level objectives. The embodiment may generate a second set of constraints corresponding to relationships within a target cluster between the target cluster resources and the series of resource dependencies. The embodiment may detect violations of the first set of constraints, and then determine one or more remediation measures to restore the received set of service level objectives based on the second set of constraints to output the one or more remediation measures to an end user.

### BACKGROUND

The present application relates generally to computers, and more specifically to managing resources in computer systems to maintain service level objectives in container orchestration platforms using constraint propagation.

Many businesses utilize orchestration platforms for automating deployment, scaling, and management of containerized applications. Containers are lightweight packages of application code together with dependencies such as specific versions of programming language, runtimes, and libraries required to run a given software service. Such containers make it easy to share CPU, memory, storage, and network resources at the operating systems level and offer a logical packaging mechanism in which applications can be abstracted from the environment in which they run. The orchestration platform may actively scale up or down various resources being utilized at any given time to reflect workload demand changes and to meet service level objectives (SLOs) associated with the deployment of a given application for one or more tenants.

### SUMMARY

According to one embodiment, a method, computer system, and computer program product for maintaining service level objectives in container orchestration platforms using constraint propagation is provided. The embodiment may include receiving a set of service level objectives associated with deployment of an application. The embodiment may also include determining a series of resource dependencies corresponding to the received set of service level objectives for the application. The embodiment may further include generating a first set of constraints corresponding to service requirements for the received set of service level objectives. The embodiment may also include generating a second set of constraints corresponding to relationships within a target cluster between target cluster resources and the series of resource dependencies corresponding to the received set of service level objectives for the application. The embodiment may further include detecting violations of the first set of constraints. The embodiment may also include in response to detecting violations of the first set of constraints, determining one or more remediation measures to restore the received set of service level objectives based on the second set of constraints. The embodiment may further include outputting the one or more remediation measures to an end user.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment; and

FIG. 2 illustrates an operational flowchart for a process of maintaining service level objectives in container orchestration platforms using constraint propagation according to at least one embodiment; and

FIG. 3 depicts a graphical representation of two applications being deployed within an illustrative system utilizing a process of maintaining service level objectives in container orchestration platforms using constraint propagation according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to managing resources in computer systems, and more particularly, to maintaining service level objectives in container orchestration platforms using constraint propagation. The following described exemplary embodiments provide a system, method, and program product to, among other things, receive a set of service level objectives associated with deployment of an application, determine a series of resource dependencies corresponding to the received set of service level objectives for the application, generate a first set of constraints corresponding to service requirements for the received set of service level objectives, and generate a second set of constraints corresponding to relationships within a target cluster between the target cluster's resources and the series of resource dependencies corresponding to the received set of service level objectives for the application. The following described exemplary embodiments may then detect violations of the first set of constraints, and, in response to detecting violations of the first set of constraints, determine one or more remediation measures to restore the received set of service level objectives based on the second set of constraints, and output the one or more remediation measures to an end user. Therefore, the presently described embodiments have the capacity to improve maintenance of service level objectives in container orchestration platforms using constraint propagation information. Described embodiments allow for modeling of quantitative behavior of containers on a target cluster's resources using constraints to determine, based on relationships between a given service level objective and relevant resource dependencies, what externalities may occur in the event of resource reallocation. Described embodiments may then utilize constraint propagation algorithms combined with the use of cloud service automation to maintain service level objectives while minimizing impact on other SLOs (corresponding to the same or different tenants or applications) that may be impacted by altering allocation of the target cluster's resources. This ultimately allows the described embodiments to output a set of potential remediation measures for an end user to choose from based on their individual priorities.

As previously described, many businesses utilize orchestration platforms for automating deployment, scaling, and management of containerized applications. Containers are lightweight packages of application code together with dependencies such as specific versions of programming language, runtimes, and libraries required to run a given software service. Such containers make it easy to share CPU, memory, storage, and network resources at the operating systems level and offer a logical packaging mechanism in which applications can be abstracted from the environment in which they run. The orchestration platform may actively scale up or down various cluster resources being utilized at any given time to reflect workload demand changes and to meet service level objectives associated with the deployment of a given application for one or more tenants.

The term “service level objective” (SLO) refers to a target level of reliability for a service. The SLO for an application may be defined declaratively as constraints between the orchestration platform resources and objective characteristics. In the context of orchestration systems and deployment of applications, there may be, for example, a SLO for a given metric such as response time. Accordingly, a numerical value corresponding to a target level of service reliability for response time, sometimes referred to as latency, may be set at less than or equal to 5 milliseconds. Many orchestration platforms allow tenants to set up independent sets of SLOs related to their applications. Site reliability engineers (SRE's) typically manage the SLOs across different applications and tenants to maintain the integrity of clusters being utilized by a given orchestration platform.

However, SRE's often experience unexpected challenges when attempting to resolve violations of a given SLO. This is because taking steps to resolve a given SLO violation for a target cluster, for example, by scaling up pods, can often impact the resources allocated to other tenants, causing violations in other parts of the target cluster or associated clusters. While intelligent rebalancing of resources within the target cluster may be a desirable solution to detecting an SLO violation, the above-described negative externalities experienced from attempting to rebalance the resource allocation within a given target cluster often prevents practical use of such an approach. As a result, many SRE's resort to a blunt approach in which they simply deploy additional resources and hardware to address the SLO violation. However, this approach is not optimal and ultimately represents an undesirable and inefficient use of additional cluster resources where it may not be needed.

Accordingly, a method, computer system, and computer program product for improving maintenance of service level objectives in container orchestration platforms using constraint propagation is provided. The method, system, and computer program product may automatically detect participants of an online meeting and generate a participant information table including participant information. The method, system, computer program product may receive a set of service level objectives associated with deployment of an application. The method, system, computer program product may determine a series of resource dependencies corresponding to the received set of service level objectives for the application. The method, system, computer program product may then generate a first set of constraints corresponding to service requirements for the received set of service level objectives. The method, system, computer program product may then generate a second set of constraints corresponding to relationships within a target cluster between the target cluster's resources and the series of resource dependencies corresponding to the received set of service level objectives for the application. Then, the method, system, computer program product may detect violations of the first set of constraints. The method, system, computer program product may then, in response to detecting violations of the first set of constraints, determine one or more remediation measures to restore the received set of service level objectives based on the second set of constraints. Thereafter, the method, system, computer program product may output the one or more remediation measures to an end user. In turn, the method, system, computer program product has provided for improved maintenance of service level objectives in container orchestration platforms using constraint propagation information. Described embodiments allow for modeling of quantitative behavior of containers on a target cluster's resources using constraints to determine, based on relationships between a given service level objective and relevant resource dependencies, what externalities may occur in the event of resource reallocation. Described embodiments may then utilize constraint propagation algorithms combined with the use of cloud service automation to maintain service level objectives while minimizing impact on other SLOs (corresponding to the same or different tenants or applications) that may be impacted by altering allocation of the target cluster's resources. This ultimately allows the described embodiments to output a set of potential remediation measures for an end user to choose from based on their individual priorities.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

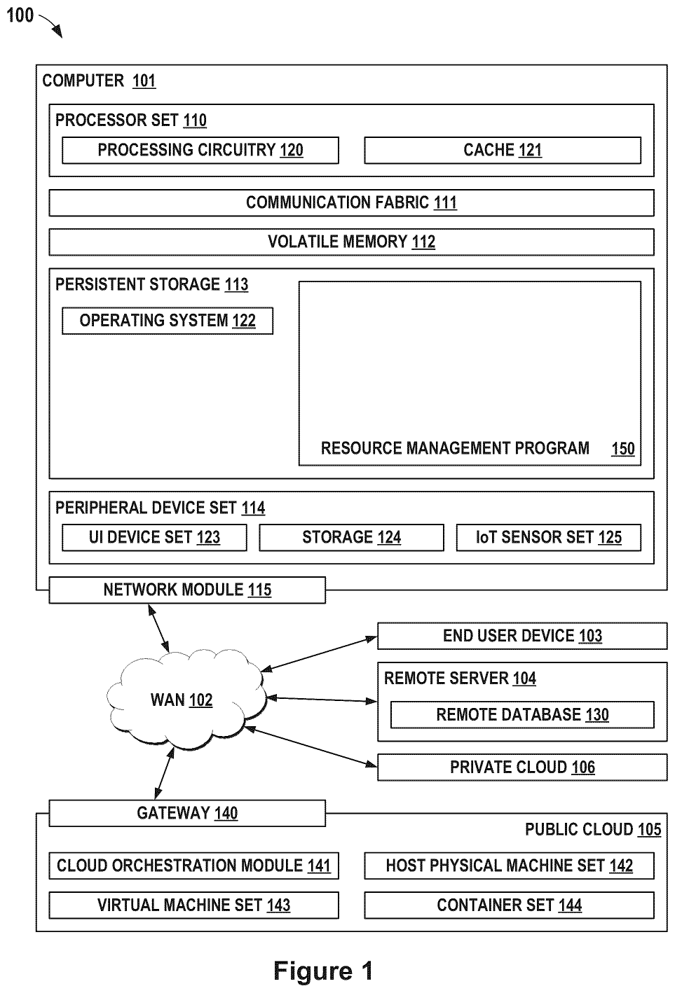

Referring now to FIG. 1, computing environment 100 contains an example of an environment for the execution of at least some of the computer code involved in performing the inventive methods, such as resource management program/code 150. In addition to resource management code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and resource management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in resource management code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in resource management code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the resource management program 150 may be a program capable of receiving a set of service level objectives associated with deployment of an application. Resource management program 150 may then determine a series of resource dependencies corresponding to the received set of service level objectives for the application. Next, resource management program 150 may generate a first set of constraints corresponding to service requirements for the received set of service level objectives. Resource management program 150 may then generate a second set of constraints corresponding to relationships within a target cluster between the target cluster's resources and the series of resource dependencies corresponding to the received set of service level objectives for the application. Next, resource management program 150 may detect violations of the first set of constraints. Resource management program 150 may then, in response to detecting violations of the first set of constraints, determine one or more remediation measures to restore the received set of service level objectives based on the second set of constraints Thereafter, resource management program 150 may output the one or more remediation measures to an end user. Described embodiments thus provide for improved maintenance of service level objectives in container orchestration platforms using constraint propagation information. Described embodiments allow for modeling of quantitative behavior of containers on a target cluster's resources using constraints to determine, based on relationships between a given service level objective and relevant resource dependencies, what externalities may occur in the event of resource reallocation. Described embodiments may then utilize constraint propagation algorithms combined with the use of cloud service automation to maintain service level objectives while minimizing impact on other SLOs (corresponding to the same or different tenants or applications) that may be impacted by altering allocation of the target cluster's resources. This ultimately allows the described embodiments to output a set of potential remediation measures for an end user to choose from based on their individual priorities.

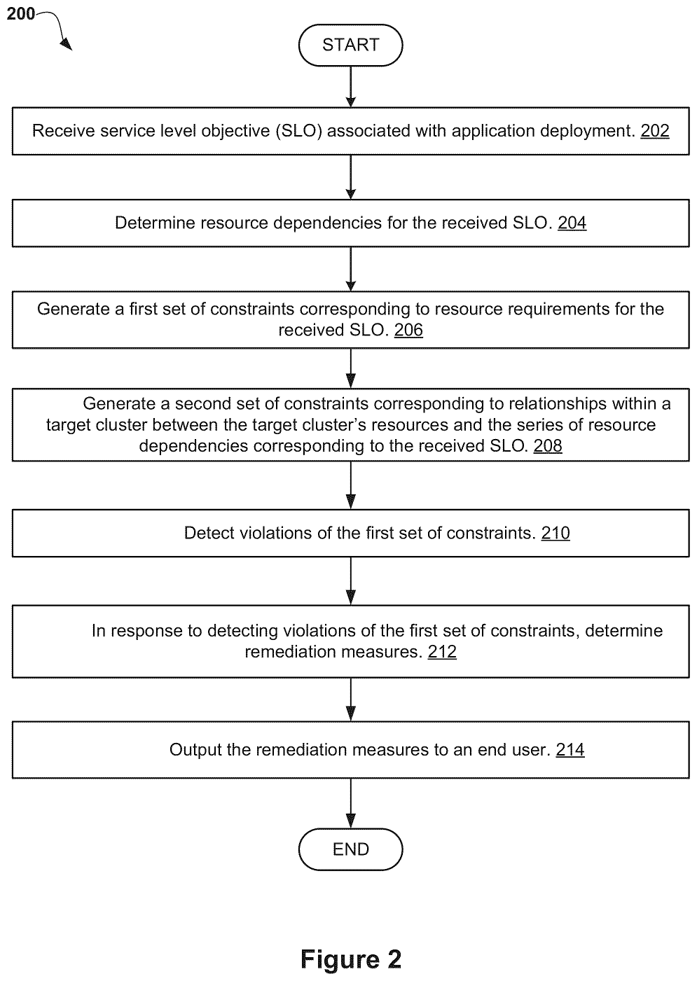

Referring now to FIG. 2, an operational flowchart for flowchart for a process 200 of maintaining service level objectives in container orchestration platforms using constraint propagation according to at least one embodiment is provided.

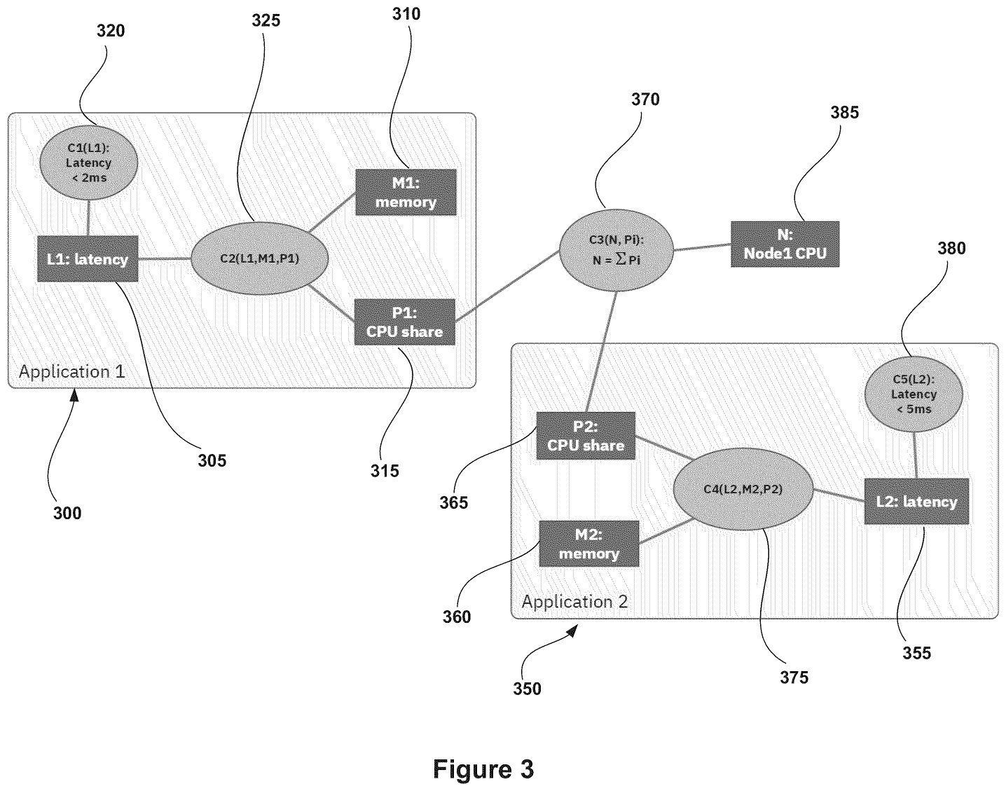

Resource management program 150 may be configured to be employed with any suitable container orchestrator platform to carry out the illustrative processes described herein. FIG. 3 depicts an illustrative graphical representation of two applications, ‘Application 1’ at 300 and ‘Application 2’ at 350, being deployed by a container orchestrator system employing an exemplary resource management to preform illustrative processes of maintaining service level objectives in container orchestration platforms using constraint propagation according to at least one illustrative embodiment. In FIG. 3, the rectangular ‘L’ nodes, shown at 305 and 355 respectively, represent SLOs having associated SLO values for a given metric, in this case latency, associated with deployment of an application. The remaining rectangular shaped nodes represent cluster resource nodes supporting the deployment of the application. In FIG. 3, some illustrative cluster resource nodes include nodes M1 for memory at 310 and P1 for CPU share at 315. Lastly, the ‘C’ nodes represent implemented constraints between the resource nodes and the ‘L’ nodes. In FIG. 3, some illustrative ‘C’ nodes include node ‘C1’ at 320 representing a constraint on L1 corresponding to a latency being less than 2 milliseconds, and ‘C2’ at 325 representing a constraint on variables L1, M1, and P1 as resource management program 150 has determined that there is resource dependency between L1 and variables M1 and P1. The example shown in FIG. 3 will be referenced throughout the description of resource management program 150 and illustrative process 200 and will be discussed in greater detail below.

It should further be noted, that before performing process 200, resource management program 150 may be configured to identify pre-existing constraint models existing for a target cluster that will be utilized by any exemplary orchestration system with which resource management program 150 is being employed. In the illustrative graphical representation shown in FIG. 3, a pre-existing constraint model C3 represents the available cluster resources, in this case, memory and allocation of central processing unit (CPU) share. Exemplary pre-existing constraints may represent the availability of any suitable cluster resource that may be managed by resource management program 150. More specifically, pre-existing constraint C3 represents the relationship between the total available CPU for exemplary node ‘N’ of a target cluster and the CPU shares being allocated to the applications that will be deployed by node ‘N’, in this case, ‘Application 1’ and ‘Application 2’. There may be a similar pre-existing constraint for memory. With the availability of pre-existing constraint model C3, resource management program 150 may perform process 200 upon the deployment of a new application using resources of the applicable target cluster associated with pre-existing constraint C3, or if a new SLO is received with a previously deployed application (‘Application 1’ or ‘Application 2 in FIG. 3) which would require a new constraint model be added. Process 200 will now be described below.

At 202, resource management program 150 may receive a set of service level objectives associated with deployment of an application. As previously discussed, in the context of this disclosure, the term ‘service level objective’ (SLO) refers to a target level of reliability for a service. In the context of orchestration systems and deployment of applications, there may be, for example, a SLO for a given metric such as response time. Accordingly, a numerical value corresponding to a target level of reliability for response time, sometimes referred to as latency, may be set at less than or equal to 5 milliseconds. Many orchestration platforms allow tenants to set up independent sets of SLOs related to their applications. Site reliability engineers (SRE's) typically manage the SLOs across different applications and tenants to maintain the integrity of clusters being utilized by a given orchestration platform. Using the example shown in FIG. 3, at this step, resource management program 150 may a first SLO ‘L1’ at 305 associated with deployment of an ‘Application 1’ at 300, and a second SLO ‘L2’ at 355 associated with deployment of a second ‘Application 2’ at 350. In this example, SLO ‘L1’ and ‘L2’ are each related to latency (response time). Resource management program 150 may be configured to receive a set of service level objectives related to any known or desired metric that may be measured or altered during deployment of an application.

Next, at 204, resource management program 150 may determine a series of resource dependencies corresponding to the received set of service level objectives for the application. At this step resource management program 150 essentially maps specific cluster resources to the received service level objective by identifying the cluster resources upon which the service level objective is dependent. In other words, resource management program 150 determines which cluster resources may be scaled up or down to influence metrics corresponding to the received service level objective. For example, returning to FIG. 3, resource management program 150 would determine at this step that the received service level objective related to latency (response time) is impacted by cluster resources including allocation of memory and allocation of central processing unit (CPU) share (e.g. processing power).

At 206, resource management program 150 may generate a first set of constraints corresponding to service requirements for the received set of service level objectives. The first set of constraints represents a value or metric corresponding to the received SLO that must be maintained. Accordingly, a violation of any constraint in the first set of constraints would correspond to a failure to meet the received SLOs. For example, in the graphical representation depicted in FIG. 3, resource management program 150 generated a first set of constraints including ‘C1’ at 320 for SLO ‘L1’ at 305. Constraint C1 corresponds to the service requirement for the SLO ‘L1’ related to latency and enforces a latency of less than 2 milliseconds. If the latency becomes greater than or equal to 2 milliseconds, than a violation of the constraint may be observed, indicating that the SLO has not been maintained.

At 208, resource management program 150 may generate a second set of constraints corresponding to relationships within a target cluster between the target clusters resources and the series of resource dependencies corresponding to the received set of service level objectives for the application. In other words, resource management program 150 may generate a series of constraints for the target cluster resources that are found to influence the service level objective. For example, in FIG. 3, resource management program 150 may generate second constraint ‘C2’ at 325 associated with the SLO regarding latency. ‘C2’ indicates that latency L1 for application 1 varies as a function of certain allocated cluster resources including memory M1 and processing power or CPU share P1. In other words, the latency for ‘Application 1’ will change as the amount of memory M1 and CPU share P1 made available to Application 1 are increased or decreased.

In embodiments, resource management program 150 may be configured to utilized machine learning techniques to train itself on how resource allocation affects certain SLOs. For example, in embodiments, the relationship enforced by constraint ‘C2’ on variables L1, M1, and P1 and the semantics of the constraints may be derived through utilizing a regression model built by monitoring the resource dependencies for the deployed application corresponding to the received SLO, allowing the cluster's constraint model to continuously learn from observed values of L1, M1, and P1, while the application is processing workloads. Once a regression model has been sufficiently trained, resource management program 150 may be able to use an exemplary cluster constraint to not only estimate the SLO metric from known resource allocations, but also to estimate allocation of a specific resource based on SLO metric and known allocation of another resource. For example, once the regression model for exemplary constraint ‘C2’ is sufficiently trained, resource management program 150 could estimate latency L1 form M1 and P1, but also could estimate memory M1 given L1 and P1, or CPU share P1 given L1 and M1. Resource management program 150 may employ these techniques to, over time, improve understanding of how changes in resource allocation for a deployed application will affect service level objectives. Resource management program 150 may even be configured, as shown in FIG. 3, to be employed for an orchestration platform for which a target cluster is being used to allocate resources to multiple application deployments. In this case, resource management program 150 may use similar techniques to continuously learn how resource allocation for the first application deployment may affect SLOs and resource allocation for a second deployed application, allowing for resource allocation rebalancing at later steps in process 200. In other embodiments, the semantics of the generated second set of constraints may be preconfigured or defined explicitly by a user.

In embodiments, certain applications may be deployed using an orchestration system that is employing resource management program 150 without an associated SLO. In this case, the first set of constraints would not be generated, as there are no requirements to meet an SLO. The second set of constraints may still be generated to establish relationships between various resources within an associated target cluster, such that the addition of any future SLO would be more easily managed and maintained. Resource management program 150 may further be configured to delete unnecessary or unused constraint models when applications are undeployed, or if SLOs are removed. Once resource management program 150 has added and removed constraint models as described above based on received SLOs (steps 202 to 208), resource management program 150 may then execute the models as described below at steps 210 to 214, during which continuous constraint propagation is occurring in the background to maintain the received SLOs.

Next, at 210, resource management program 150 may detect violations of the first set of constraints. Because the first set of constraints correspond to service requirements for the received set of SLOs, a violation of the first set of constraints represents a failure to maintain a SLO. Resource management program 150 may detect violations of the first set of constraints by continuously measuring the operation of the deployed application against the defined constraints using any suitable known monitoring techniques. Returning to FIG. 3, at this step, resource management program 150 may detect, for example, that the latency for deployed ‘Application 1’ has increased to 3 milliseconds, a metric value that is above the service requirement corresponding to the first constraint ‘C1’ which requires latency to be less than 2 milliseconds.

At 212, resource management program 150 may, in response to detecting violations of the first set of constraints, determine one or more remediation measures to restore the received set of service level objectives based on the second set of constraints. In embodiments, resource management program 150 utilizes constraint propagation algorithms that rely on the learning mechanisms described above to continuously learn about the semantic relationships between the applicable cluster's resources and the received SLO. As the accuracy of the cluster's constraint model increases over time from the continuous learning, the accuracy of the remediation measures generated by resource management program 150 will increase. Resource management program 150 may be configured to generate multiple possible remediation measures, each of which are designed to restore global consistency across the cluster while maintaining all received SLOs but may sacrifice or reallocate different resources to achieve this state. Resource management program 150 may accomplish this using a solving engine (not shown) to solve the generated sets of constraints and find a global, optimal re-allocation plan in a way that is extensible and flexible. In embodiments, resource management program 150 may be configured to assign scores to each determined remediation measure that may be useful to a SRE when determining which remediation measure to apply. For example, resource management program 150 may output multiple remediation measures and subsequently assign scores to each remediation measure that may be based on one or more of key performance indicators or objective functions, such as least number of changes applied to resource distribution. In other examples, resource management program 150 may assign scores that are based on a preconfigured prioritized resource or application. For example, resource management program 150 may assign scores to determined remediation measures based on prioritizing updates to CPU share, memory, or any other resource or application. The constraint propagation algorithms described above and applied by resource management program 150 allow for maintenance of global consistency in the network based on local constraint semantics that are learned over time. This allows resource management program to be able to simulate what changes would occur to various SLO metrics as resource allocations are altered. This allows for the preferred approach of taking remediation measures to rebalance resources as opposed to more blunt approach of assigning additional resources from the cluster. In embodiments, resource management program 150 uses the above-described declarative, constraint-based modeling of the received SLO and the relationships between the deployed applications and the cluster resources, which allows the system to take into account as many details and characteristics of the environment (application and resources) without having to change the implementation of a suitable re-allocation engine used to alter the allocated cluster resources. In embodiments, the re-allocation engine (not shown) configured to be engaged with and utilized by resource management program 150 and the orchestration platform employing resource management program 150 is independent from the declarative, executable model defined by the constraint network. An illustrative example using the graphical representation of FIG. 3 will be described below for clarity.

In FIG. 3, an orchestration platform is devoting resources from a target cluster to deploy two applications, ‘Application 1’ at 300 and ‘Application 2’ at 350 respectively. An exemplary resource management program 150 as described above is being utilized by the orchestration platform. A scenario is imagined in which received SLOs ‘L1’ at 305 and ‘L2’ at 355 correspond to latency or response time. Accordingly, resource management program 150 generates a first set of constraints ‘C1’ at 320 and C5′ at 375 corresponding to the service requirement for each of the received SLOs. ‘C1’ indicates that latency must be less than 2 milliseconds, while constraint ‘C5’ indicates that latency must be less than 5 milliseconds. In this example, resource management program 150 detects a violation of ‘C1’ at 320, one of the first set of constraints corresponding to a service requirement for SLO ‘L1’ at 305 resulting from a latency increase to 3 milliseconds, 1 millisecond above the ‘less than 2 millisecond’ requirement. This violation triggers use of one of the second set of generated constraints ‘C2’ at 325 generated by resource management program 150. Resource management program 150 determined that latency is impacted by two cluster resources including memory and CPU share. Utilizing continuous learning derived from regression models using data generated from operation of ‘Application 1’ and ‘Application 2’ processing workloads over time, the second set of generated constraints allow resource management program 150 to determine that possible remediation measures for the detect violation above would require increasing the amount of allocated memory or CPU share, represented as ‘M1’ at 310 and ‘P1’ at 316 respectively. In one exemplary remediation measure, resource management program 150 may recommend increasing CPU share at P1. Resource management program 150 would then use C2 to determine the CPU increase needed to bring the latency back down to 2 milliseconds to maintain the SLO. However, in this example, the orchestration platform is utilizing the same cluster to deploy a second ‘Application 2’. As previously mentioned, resource management program 150 received additional SLOs for ‘Application 2’ and therefore generates additional sets of applicable constraints. Because the cluster resources required by ‘Application 1’ and ‘Application 2’ both include CPU, as determined from the second set of constraints generated at both ‘C2’ at 325 and ‘C4’ at 375, resource management program 150 may generate a constraint ‘C3’ at 370 for an exemplary cluster node ‘N’ at 385 indicating that the sum of the CPU share utilized in each application may not exceed the available CPU share from node ‘N’. Therefore, applying the exemplary remediation measure discussed above in which the CPU share at ‘P1’ is raised to lower latency L1, will also trigger constraint ‘C3’ and result in a decrease in ‘P2’, the CPU share of ‘Application 2’. This change triggers constraint ‘C4’ which results in raising latency ‘L2’ to, for example, 4 milliseconds. While this change triggers and involves constrain ‘C5’ at 380 which corresponds to a service requirement of less than 5 milliseconds for ‘L2’ at 355, the increase to 4 milliseconds does not violate the constraint, and therefore no additional update would be needed.

To summarize the above example, the result of the detected violation of constraint ‘C1’ due to increased latency ultimately resulted in resource management program 150 determining 2 corrective actions to reestablish the SLO, namely raising CPU share ‘P1’ and CPU share ‘P2’ to values prescribed by the constraints ‘C2’ and ‘C4’ in view of ‘C3’. Resource management program 150 also validated that applying the remediation measure would not indirectly entail any SLO violations in the overall set of workloads deployed on the cluster. By looking for a globally consistent state based on local, declarative constraints, the constraint propagation algorithm utilized by resource management program 150 ensures that resources available in the cluster are not underutilized and avoids resorting to the brute force approaches requiring the deployment of more hardware or resources.

Lastly, at 214, resource management program 150 may output the one or more remediation measures to an end user. The remediation measure may be presented as an output to an end user using any suitable user interface. As discussed above, the output remediation measures may further include assigned scores therewith that may be based upon preconfigured metrics that the end user may wish to prioritize. For example, assigned scores may be numerical values between 0 and 10, where higher scores correspond to remediation measures involving the least number of changes needed to perform the remediation measure.

In some embodiments, resource management program 150 may determine that there are no viable remediation measures involving resource rebalancing within the target cluster and that additional cluster resources are required to address the detected constraint violation. Accordingly, resource management program 150 may, if all the target cluster resources are exhausted, provide for secondary remediation measures involving additional cluster resources being deployed from a second cluster. After employing this last resort measure, resource management program 150 may then return to employing process 200 as described above to ensure resource rebalancing is prioritized wherever possible.

In yet another embodiment, resource management program 150 may be configured to automatically select and apply the generated remediation measure having the highest score (ranking) such that certain critical applications that may benefit from immediate reaction to SLO degradation may be maintained accordingly.

It will be appreciated that resource management program 150 thus provides for improved maintenance of service level objectives in container orchestration platforms using constraint propagation information. Described embodiments allow for modeling of quantitative behavior of containers on a target cluster's resources using constraints to determine, based on relationships between a given service level objective and relevant resource dependencies, what externalities may occur in the event of resource reallocation. Described embodiments may then utilize constraint propagation algorithms combined with the use of cloud service automation to maintain service level objectives while minimizing impact on other SLOs (corresponding to the same or different tenants or applications) that may be impacted by altering allocation of the target cluster's resources. This ultimately allows the described embodiments to output a set of potential remediation measures for an end user to choose from based on their individual priorities.

It may be appreciated that FIG. 2 provides only illustrations of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of maintaining service level objectives in container orchestration platforms using constraint propagation comprising:
receiving a set of service level objectives associated with deployment of an application;
determining a series of resource dependencies corresponding to the received set of service level objectives for the application;
generating a first set of constraints corresponding to service requirements for the received set of service level objectives;
generating a second set of constraints corresponding to relationships within a target cluster between the target cluster resources and the series of resource dependencies corresponding to the received set of service level objectives for the application;
detecting violations of the first set of constraints;
in response to detecting violations of the first set of constraints, determining one or more remediation measures to restore the received set of service level objectives based on the second set of constraints; and
outputting the one or more remediation measures to an end user.

2. The computer-based method of claim 1 further comprising:
automatically assigning scores to each of the one or more remediation measures; and
outputting the assigned scores to the end user.

3. The computer-based method of claim 2, wherein the assigned scores are based on resource distribution changes required or expected changes to a preconfigured prioritized resource.

4. The computer-based method of claim 1, wherein semantics of the generated second set of constraints are defined explicitly.

5. The computer-based method of claim 1, wherein semantics of the generated second set of constraints are continuously updated by employing regression models built by monitoring the series of resource dependencies corresponding to the received service level objectives.

6. The computer-based method of claim 1 further comprising:
automatically selecting and applying a highest-scoring remediation measure to the target cluster.

7. The computer-based method of claim 1, further comprising:
determining that additional resources are required to address the detected violation; and
outputting a secondary remediation measure including a recommendation to allocate additional resources from another cluster.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving a set of service level objectives associated with deployment of an application;
determining a series of resource dependencies corresponding to the received set of service level objectives for the application;
generating a first set of constraints corresponding to service requirements for the received set of service level objectives;
generating a second set of constraints corresponding to relationships within a target cluster between the target cluster resources and the series of resource dependencies corresponding to the received set of service level objectives for the application;
detecting violations of the first set of constraints;
in response to detecting violations of the first set of constraints, determining one or more remediation measures to restore the received set of service level objectives based on the second set of constraints; and
outputting the one or more remediation measures to an end user.

9. The computer system of claim 8, further comprising:
automatically assigning scores to each of the one or more remediation measures; and
outputting the assigned scores to the end user.

10. The computer system of claim 9, wherein the assigned scores are based on resource distribution changes required or expected changes to a preconfigured prioritized resource.

11. The computer system of claim 8, wherein semantics of the generated second set of constraints are defined explicitly.

12. The computer system of claim 8, wherein semantics of the generated second set of constraints are continuously updated by employing regression models built by monitoring the series of resource dependencies corresponding to the received service level objectives.

13. The computer system of claim 8, further comprising:
automatically selecting and applying a highest-scoring remediation measure to the target cluster.

14. The computer system of claim 8, further comprising:
determining that additional resources are required to address the detected violation; and
outputting a secondary remediation measure including a recommendation to allocate additional resources from another cluster.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving a set of service level objectives associated with deployment of an application;
determining a series of resource dependencies corresponding to the received set of service level objectives for the application;
generating a first set of constraints corresponding to service requirements for the received set of service level objectives;
generating a second set of constraints corresponding to relationships within a target cluster between the target cluster resources and the series of resource dependencies corresponding to the received set of service level objectives for the application;
detecting violations of the first set of constraints;
in response to detecting violations of the first set of constraints, determining one or more remediation measures to restore the received set of service level objectives based on the second set of constraints; and
outputting the one or more remediation measures to an end user.

16. The computer program product of claim 15, further comprising:
automatically assigning scores to each of the one or more remediation measures; and
outputting the assigned scores to the end user.

17. The computer program product of claim 16, wherein the assigned scores are based on resource distribution changes required or expected changes to a preconfigured prioritized resource.

18. The computer program product of claim 15, wherein semantics of the generated second set of constraints are defined explicitly.

19. The computer program product of claim 15, wherein semantics of the generated second set of constraints are continuously updated by employing regression models built by monitoring the series of resource dependencies corresponding to the received service level objectives.

20. The computer program product of claim 15, further comprising: further comprising:
automatically selecting and applying a highest-scoring remediation measure to the target cluster.
